(19) United States
(12) Patent Application Publication
(10) Pub. No.: US 2010/0042296 A1
(43) Pub. Date: Feb. 18, 2010

(54) METHOD AND DEVICE FOR TRIGGERING A PERSONAL PROTECTION MEANS FOR A VEHICLE

(75) Inventors: Thomas Brandmeier, Wenzenbach (DE); Michael Feser, Barbing (DE); Christian Lauerer, Manching (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/440,544

(22) PCT Filed: Sep. 4, 2007
(86) PCT No.: PCT/EP07/59251

§ 371 Date: Mar. 9, 2009

(30) Foreign Application Priority Data
Sep. 12, 2006 (DE) 10 2006 042 769.6

(51) Int. Cl. B60R 21/0132

(52) U.S. Cl. 701/46

(57) ABSTRACT

A method and device for triggering a personal protection device for a vehicle, in particular, an occupant protection device in a vehicle. An acceleration sensor provides a first impact parameter Formula, compared with a triggering threshold value. A chassis noise sensor provides a second impact parameter Formula. The triggering threshold value is altered depending on the second impact parameter Formula.

The invention relates to a method and a device for triggering a personal protection means for a vehicle, in particular an occupant-protection means in a vehicle, in which a first impact sensor, in particular an acceleration sensor, provides a first impact signal, in particular an acceleration signal. A first impact variable, derived from this acceleration signal, is compared with a threshold value. Furthermore, a second impact signal of a second impact sensor is recorded, and a second impact variable, derived from the second impact signal, is formed. The threshold value, with which the first impact variable is compared, is fashioned so as to vary as a function of the second impact variable, at least partially for a range of values of the impact variable, whereas in another range of values of the second impact variable it can also be held constant. The personal protection means is triggered, preferably only, when the acceleration signal exceeds the threshold value.

Such a device is known from European patent EP 0 458 796 B2. There, a method for triggering restraining means in a safety system for vehicle occupants is described, in which a detected acceleration signal or a signal derived therefrom is compared against a threshold value which is variable as a function of one or more impact variables which is/are derived from one or more signals by one or more sensors which can be arranged in a distributed manner in the vehicle (Claims 1 and 9 there and column 12, lines 33 to 42). An occupant-protection means is triggered only when the acceleration signal or a signal derived therefrom exceeds this variable threshold value.

Methods of this kind and devices which use such methods serve to protect persons who are involved in a vehicle accident. Sensors, for example acceleration sensors, pressure sensors, etc., are used in order to trigger a personal protection means within a personal protection system as soon as a vehicle accident occurs.

Personal protection means can be considered to include on the one hand occupant-protection means such as, for example, airbags, belt-tensioners or other functional elements for protecting occupants during a vehicle accident such as, for example, movement of a vehicle seat away from the accident zone, for example in the direction of the rear of the vehicle once a frontal accident becomes evident, or other functions such as, for example, closure of the sliding roof or the like. A personal protection system is, however, also understood to include, for example, a pedestrian protection system which, once a collision with a pedestrian is detected, can trigger corresponding pedestrian protection means. For example, the hood can then be raised in order to lower the impact of the pedestrian concerned against the hood so that the rigid engine block located directly under the hood cannot cause excessive injuries to the pedestrian.

The sensor technology used for detecting an impact has to be able to identify information about the characteristics of the impact in as short a time as possible so that suitable protection means can be triggered. The time available for safe detection is generally substantially shorter in the case of a lateral impact on the vehicle than it is in relation to a frontal collision.

For detecting frontal impact accidents, acceleration sensors are primarily used which are connected as rigidly as possible to the vehicle body and may be arranged, for example, on the vehicle tunnel, mainly inside the central control unit (for an occupant-protection system) or else, optionally additionally, at one or more points in the front of the vehicle or in the side of the vehicle.

The high safety requirements with regard to personal protection in automotive engineering, however, increasingly require that, in order to trigger an occupant-protection means, not only is the signal of just one such sensor often used, but also, at least for plausibility checking purposes, the signal of a second sensor. This may be, for example in combination with an acceleration sensor, a further acceleration sensor at one of the aforementioned positions in the motor vehicle, but also a pressure sensor inside a cavity in the vehicle front or else a structure-borne sound sensor.

A combination of the signals of two impact sensors can by changing the threshold-value characteristic curve, against which the signal of the first sensor is compared, as a function of the signal of a second sensor, as described, for example in the above patent specification EP 0 458 796 B2.

The simultaneous use of acceleration sensors and structure-borne sound sensors for triggering an occupant-protection means is described in the European patent specification EP 0 305 654 B1.

This follows also from EP 1 019 271 B1: here, a device for protecting occupants in a motor vehicle is shown, comprising a sensor for detecting an excursion of structure-borne sound of a bodywork component of the motor vehicle, in which the sensor detects a transversal excursion of structure-borne sound in the bodywork component of the motor vehicle in order to control an occupant-protection means of the motor vehicle as a function of the detected structure-borne sound.

DE 10 2005 020 146 A1 (see figure and [0019]-[0029]) discloses a method for triggering a personal protection means for a vehicle, comprising a first impact sensor, which is an acceleration sensor and provides an acceleration signal as a first impact signal, and comprising a second impact sensor, which is a structure-borne sound sensor and provides a structure-borne sound signal as a second impact signal. The second impact signal (structure-borne sound signal) is variable, depending on whether the impact object concerned is a pedestrian, another vehicle, a tree or else merely a ball or a stone. Only in a case where the collision object concerned is a pedestrian is a triggering signal sent to the personal protection system, which is fashioned here as a pedestrian protection system, the pedestrian protection system being activated to protect the pedestrian. Depending on the severity of the collision, which can be determined on the one hand from the signals of the first impact sensor (acceleration sensor) and in a particular way from the signals of the second impact sensor (structure-borne sound sensor), an occupant-protection system can be triggered in a targeted manner or not triggered.

A common arrangement in a vehicle nowadays of acceleration sensors and/or other impact sensors, whose signals are used for triggering one or more occupant-restraining means, is an acceleration sensor sensitive to acceleration in the direction of travel which on or inside the central control unit of an occupant-restraining system in the vehicle center, preferably on the vehicle tunnel, and two decentralized sensors in the left-hand and right-hand front of the vehicle. Such decentralized sensors are often referred to as satellites. The decentralized sensors may be fashioned as early crash sensors (ECS), i.e. they can communicate at a very early stage to the central control unit first acceleration signals which are caused by an impact. These signals are normally used not only as an early warning in the central control unit, but also as signals giving plausibility values for the acceleration signal of the acceleration sensor arranged centrally in the control unit.

As a result, however, of the cabling of two decentralized sensors and also because normally not just the sensors but also signal-processing and evaluating electronics and communication electronics may be arranged in the satellites, such an arrangement is not only more time-consuming to produce and therefore more expensive but also more prone to interference. Reducing the number of early crash sensors (ECS) or dispensing completely with any such decentralized sensor unit (satellite) in occupant-protection systems, particularly for frontal impact detection, would, if impact detection suitability remained unchanged, be advantageous here.

However, it has been shown in crash tests that, particularly where only one acceleration sensor is used for frontal impact detection, particularly inside the central control unit of an occupant-protection system, certain impact types can be distinguished from one another only with difficulty. In particular, in ODB crash tests (ODB: offset deformable barrier), in which deformable objects overlapping to differing degrees with the front of the vehicle strike mainly laterally against the vehicle front, “soft crashes” can be distinguished only with difficulty from “hard crashes”, for example impact accidents against a hard wall or against comparatively non-deformable objects overlapping to differing degrees with the vehicle front in insurance crash tests, for example the AZT crash tests of the Allianz Center for Technology.

The object of the invention is consequently to be better able to distinguish between different types of impact in vehicles. The object is achieved in a method according to claim 1. The object is achieved furthermore in a device according to claim 7.

In the inventive method for triggering a personal protection means for a vehicle, in particular an occupant-protection means in a vehicle, a first impact sensor, an acceleration sensor, provides a first impact signal, namely an acceleration signal, from which a first impact variable is derived and is compared with a threshold value. A second impact sensor provides a second impact signal, from which a second impact variable is formed. The threshold value is fashioned so as to vary as a function of the second impact variable. The personal protection means is triggered only when the first impact variable exceeds the threshold value. The triggering can also be made dependent on further criteria. The inventive method is characterized in that the second impact sensor is a structure-borne sound sensor, the second impact signal a structure-borne sound signal and the second impact variable a measure of the sound power, the sound power, the mean sound power or the sound energy of the structure-borne sound signal and thus a measure of the change in volume of the vehicle during the impact. This is to be understood as meaning that the second impact variable is at least approximately proportional to at least one of the variables sound power, mean sound power and sound energy of the structure-borne sound signal and as a result is, in particular, also proportional to the change in volume.

The second impact variable is preferably formed by or at least derived from the absolute value of the measured structure-borne sound signal (aks), or of a time-normalized or non-normalized time integral thereof. In practice, these values are often used as a measure of the structure-borne sound power, of the time-averaged structure-borne sound power or of the energy of the structure-borne sound signal, often because these values are generally substantially easier to calculate than other approximation variables and the computational outlay can as a result be kept lower, which in turn optionally enables the use of cheaper processors and thereby cuts costs. Of course, other reasons may, however, also favor such an approach.

Based on analogous considerations, it may be advantageous in other exemplary embodiments if the second impact variable is formed by or at least derived from the square of the measured structure-borne sound signal (aks) or a time-normalized integral thereof, which can be equivalent in their effect to the aforementioned approximation variables but which match more closely the physical definitions for power, mean power and energy.

As a first impact variable, a measure of the change in the acceleration signal over time is preferably used. This will be explained in detail with the aid of the description of the drawings. The inventive method is not, however, in any way restricted to this specific embodiment of a first impact variable. It may under certain circumstances also be advantageous to use other variables derived from the acceleration signal as first impact variables, for example a sliding temporal mean value of the acceleration signal, the acceleration signal itself, which is always understood to mean also the acceleration signal which has optionally been suitably filtered for the application in a pre-processing step, a measure of the velocity based on an integrated acceleration value, or similar.

The invention is based on the assumption that the high-frequency structure-borne sound during an impact accident in a vehicle can approximately be approximated by a simple model of the sound-wave propagation in a homogeneous solid.

Simultaneously, the comparatively low-frequency acceleration signal is used to describe an impact accident with the aid of a simple spring-mass model, which could not previously be used because one variable, the deformation path and consequently the deformed volume of the vehicle, could not previously be obtained by measurement. This variable can now, however, be obtained from the structure-borne sound model and from measurement of the structure-borne sound through measurement. In this way, the variable which was not previously available can be used to change a triggering threshold value, against which the measured signal, the acceleration signal, or rather a first impact variable derived therefrom, is compared. In this way, types of impact which it was previously possible to distinguish only with difficulty can be distinguished from one another clearly. In particular, the impact can be classified as a “soft crash” or a “hard crash”, which is especially important in crash tests, in particular for example, in the ODB or AZT crash tests previously described further above.

The new crash model for acceleration signals is based on the assumption of a simple spring-mass model which can be described physically by means of a spring oscillation equation. From this spring-mass model, a solution for the acceleration of such a differential equation can be found for the acceleration of the vehicle. The derivation of this equation, i.e. the derivation of the acceleration, is proportional to the change in volume during the impact.

The structure-borne sound model, on the other hand, proceeds on the assumption that the sound power, the mean sound power or the sound energy of the structure-borne sound signal is also proportional to the change in volume of the vehicle during the impact. The sound power can, however, be deduced in a simple manner from the measured structure-borne sound, for example, in simplest approximation by squaring the measured structure-borne sound signal. Consequently, a second impact variable derived from the impact signal, the structure-borne sound signal, is available which is also directly proportional to the change in volume of the motor vehicle during the impact.

By means of simple considerations, the extreme conditions of a “hard crash” and of a “soft crash” can be found. From these, a threshold-value characteristic curve for the first impact variable as a function of the change in volume of the motor vehicle can be found. Both threshold-value characteristic curves can be used to trigger an occupant-protection means: if the first impact variable exceeds such a combined threshold-value characteristic curve which depends on the second impact variable, then the personal protection means is triggered.

Advantageous embodiments are specified in the subclaims.

Structure-borne sound can be defined as an elastic stress wave which propagates in a body at the speed of sound. The causes of the emergence of structure-borne sound are different microscopic and macroscopic effects. These occur during the classic deformation of materials. Here, the structure-borne sound is generated by material-physical mechanisms during deformation. The key physical effects in the plastic deformation of metals are, in particular, dislocation movements, twinning—also known as “tin cry”—, martensitic transformation, Lüders deformation, crack formation and fracture of such a solid. These microscopic changes in the crystallographic structure of the metal lead to differing excitation of the individual molecules and groups of molecules or even of individual atoms or groups of atoms during the deformation. In the process, the emission of sound which is referred to as structure-borne sound occurs.

This takes place, in particular also, during the deformation of vehicle parts during an impact accident. In particular, new types of steels and alloys such as are used in the automotive industry, for example TRIP steel, generate significant sound emissions during deformation. Common to all the physical mechanisms which contribute to the emergence of structure-borne sound is the fact that they can occur during a deformation process in the deformation zone of the vehicle. The sound power of the structure-borne sound which is produced here is dependent on the deformed volume and the velocity of deformation, as well as on the characteristics of the material or materials involved and the type of deformation. The primary additional external cause of the occurrence of structure-borne sound is friction. This inevitably occurs in the deformation zone and is also dependent on the deformed volume and the velocity of deformation. The individual sources of structure-borne sound in the deformation zone produce an overall signal which propagates in the vehicle structure at the speed of sound and can be measured at almost any point.

The transmission of the high-frequency structure-borne sound differs in speed of propagation and amplitude attenuation from the low-frequency acceleration signals generally used today to trigger occupant-restraining means, which are usually measured below a limit frequency of c. 400 Hz. Structure-borne sound is chiefly measured above this frequency. Structure-borne sound is composed moreover of several wave types. Examples of these are the flexural wave and the longitudinal wave. A flexural wave with a frequency of 400 Hz propagates in a 3 mm thick steel plate at a velocity of 100 mm/ms. The same wave type already exhibits a propagation velocity of 2400 mm/ms at a frequency of 50 kHz. The longitudinal wave exhibits no dispersive effects and in this way propagates independently of the frequency at a velocity of approx. 5000 mm/ms in the steel plate described. As a result, the structure-borne sound is provided very rapidly at the sensor position, even if this sensor position is located far from the impact location.

To check the suitability of structure-borne sound signals for triggering occupant-restraining means, numerous crash tests have been carried out on vehicles in recent years. The test vehicles were fitted with various sensors in several positions. For example, structure-borne sound sensors were mounted on the locking cross member in the front of the vehicle. In the passenger cabin, sensors were arranged on the tunnel, close to the position of the central control unit, inside the central control unit on the housing thereof or else on the printed circuit board inside the central control unit.

It was established that crash types which are difficult to distinguish, in particular, can be recognized more easily through the use of structure-borne sound signals:
the AZT insurance test with an impact velocity of 16 km/h, a 40% surface overlap of the impacting object, a rigid wall and also in the “Danner test”, in which the triggering of belt-tensioners or airbags is not meant to take place at all,
the 20 km/h crash test against a rigid wall with complete surface overlap of the impacting object, in which an airbag is again not supposed to be triggered and
the ODB crash test (ODB: offset deformable barrier) with an impact velocity of 64 km/h, as is used for example in the Euro NCAP crash tests, in which—in contrast to the two aforementioned crash tests—very rapid triggering of belt-tensioners and airbags is meant to occur.

It was established in these crash tests that many locations are suitable for mounting structure-borne sound sensors in the vehicle. Examples include the locking cross member and the center tunnel inside the passenger cabin, but a position inside the central control unit of the airbag system is also possible.

The inventive method is of benefit in that acceleration signals are measured by the acceleration sensor in a different frequency band of the generated impact signal, in particular at frequencies below 400 Hz, from the high-frequency structure-borne sound signal, which is measured in particular above 2 kHz, usually even above 4 or even 6 kHz up to 20 kHz or more.

Several advantageous variants are available for measuring both the acceleration signal and the structure-borne sound signal. For example, an acceleration sensor can be used for measuring both signal components. Here, a normal acceleration sensor, which nowadays is usually manufactured using micromechanical technology, is fashioned such that a measurement range up to 20 kHz or higher can be evaluated by means of a micromechanical sensor cell. Filters suitably connected downstream make it possible on the one hand for the low-frequency acceleration signal up to 400 Hz to be extracted and on the other for the higher-frequency signal between up to 20 kHz or more [sic]. This has the advantage that a structure-borne sound sensor and acceleration sensor combined in such a way can be arranged inside a housing, for example inside the central control unit of an occupant-protection system, but also, for example, in a frontal position in the vehicle situated closer to the expected deformation zone. In comparison to two separate sensor units, this has the advantage that not only the same micromechanical sensor cell, but also at least some of the same pre-processing and further-processing electronics and communication electronics can be used for both signal components. This firstly cuts costs and secondly is less prone to interference, for example from influences which could be caused on transmission pathways by electromagnetic interference radiation.

Such a combined sensor unit can preferably be arranged inside the central control unit. This has the advantage that the sensor signals do not, in particular, have to be digitized prior to their transmission to the evaluation unit, since they have to traverse only very short line paths to the evaluating electronics.

On the other hand, it can be advantageous in some vehicle structures for such a combined sensor unit to be arranged in a frontal position closer to the expected deformation area. There, the acceleration signals, in particular, may be present earlier than in the central control unit, as the slower acceleration signals do not first have to cover a longer route across the vehicle structure.

However, if the vehicle design and the impact signals which are to be expected as a result make it appear advisable to place the structure-borne sound sensor and the acceleration sensor in separate sensor units, each having their own housing, then the application of a method according to the invention does not in any way rule out such an arrangement.

What matters in arranging a structure-borne sound sensor and an acceleration sensor appropriately within a vehicle is the rigid connection in both cases to rigid structural elements of the vehicle, for example to longitudinal members or cross members, the vehicle tunnel, the B-pillar, the A-pillar or, as already mentioned hereinabove, the locking cross member.

To make use according to the invention of structure-borne sound signals to trigger occupant-restraining means, it is even possible to attach the structure-borne sound sensor to a lateral structure of the vehicle, as long as this provides a strong connection to the rigid vehicle structure.

The underlying physical models and an exemplary embodiment of the invention will be explained below with the aid of schematic diagrams. The same design and functional features will be designated below by the same reference characters.

Even though hitherto, and above all in the description of the drawings below, reference is made chiefly to systems for frontal impact detection, neither the inventive method nor the inventive device is restricted to frontal impact detection. Both can also be used in side impact detection.

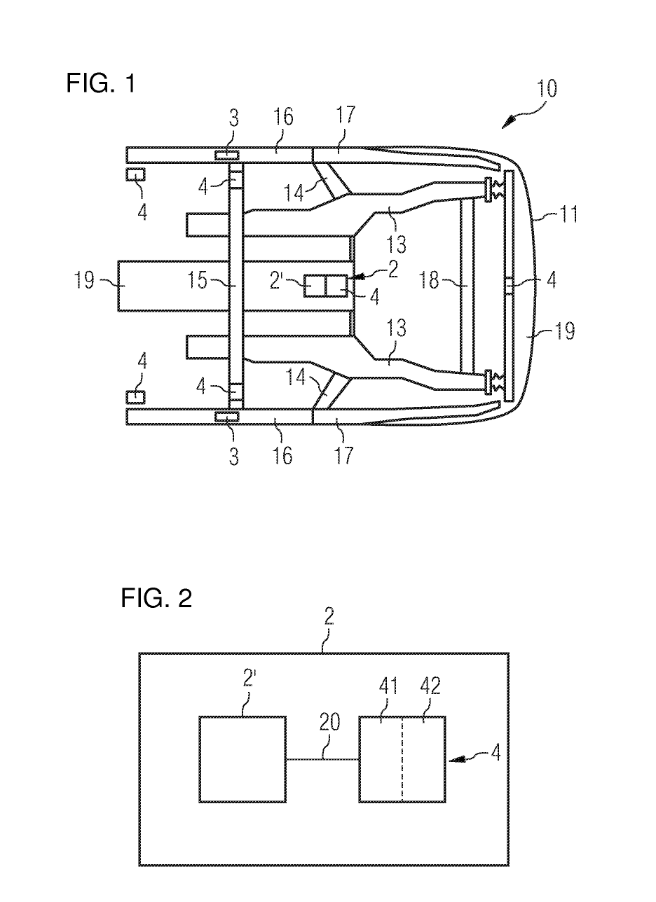

FIG. 1 shows a representation of the rigid vehicle structure and possible locations for attaching an acceleration sensor according to the invention and a structure-borne sound sensor according to the invention,

FIG. 2 shows an inventive occupant-protection device according to a first exemplary embodiment,

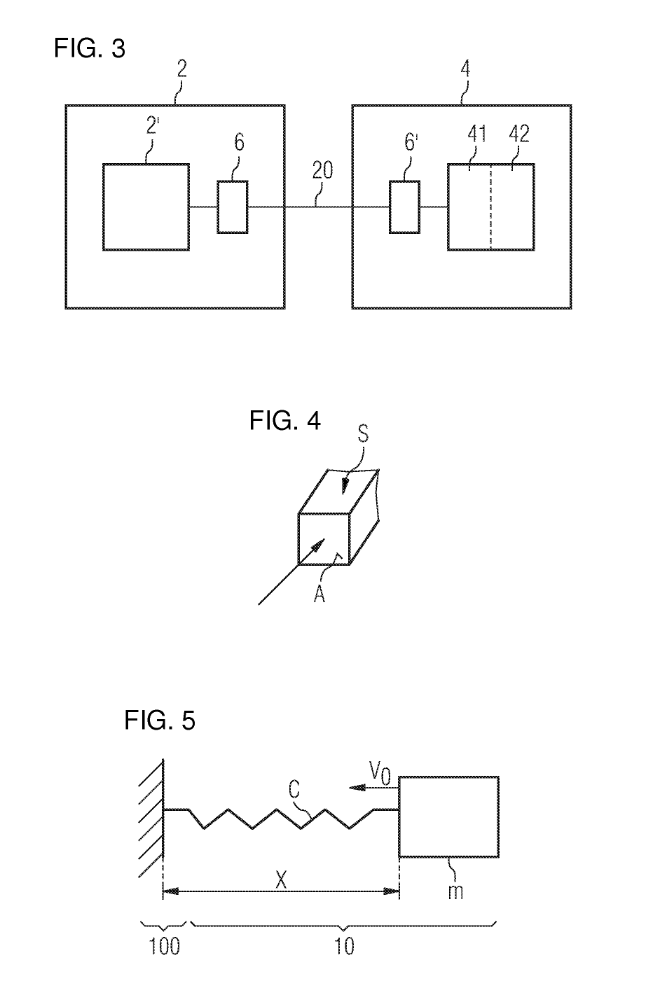

FIG. 3 shows an inventive occupant-protection device according to a second exemplary embodiment,

FIG. 4 shows a representation of the sound power model,

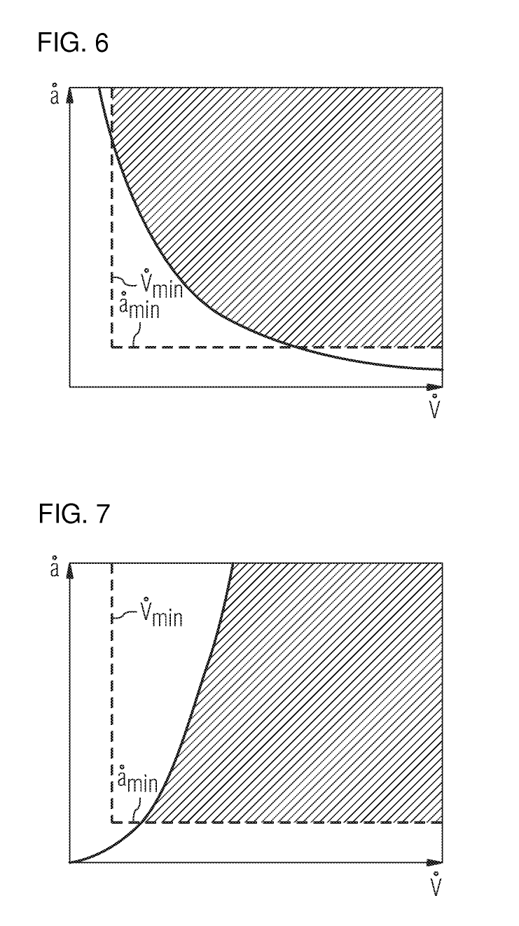

FIG. 5 shows a representation of the spring-mass model of a vehicle impact,

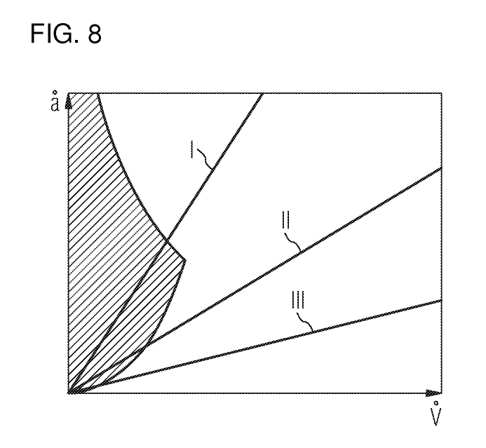

FIG. 6 shows an inventive threshold-value characteristic curve for a “hard crash”,

FIG. 7 shows an inventive threshold-value characteristic curve for a “soft crash”,

FIG. 8 shows a combined threshold-value characteristic curve according to the invention and,

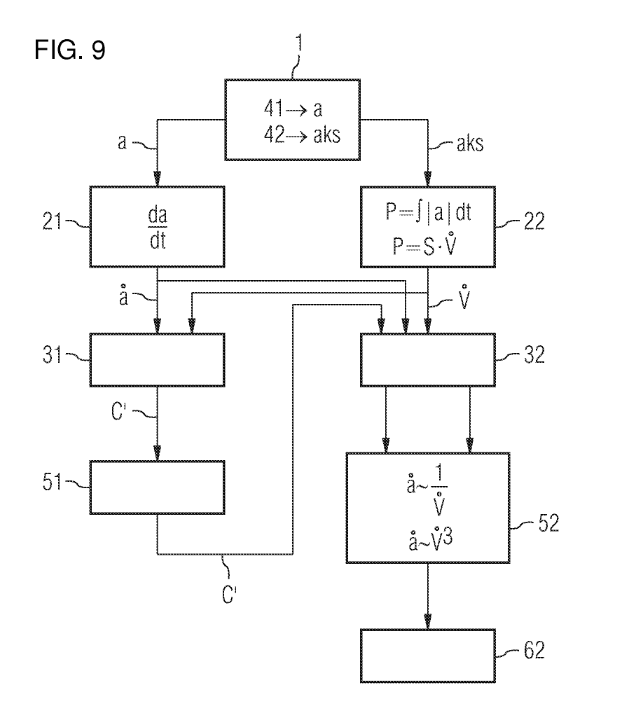

FIG. 9 shows a sequence for an exemplary embodiment of an inventive method.

FIG. 1 shows schematically the supporting bodywork components of a motor vehicle. The front section of a motor vehicle 10 is shown. This has interconnected supporting bodywork components 13, 14, 15, 17 and 18. The reference character 19 designates the vehicle tunnel of the motor vehicle, which also constitutes a supporting bodywork component. All supporting bodywork components are firmly connected to one another mechanically.

Arranged in the doors represented by the reference characters 16 are pressure-responsive sensors 3 which serve in triggering a lateral occupant-protection means. These are (not shown in the Figure) connected electrically to the evaluation unit arranged on the center tunnel 19.

The reference characters 4 show possible positions both for acceleration sensors and for structure-borne sound sensors. As previously mentioned in the introduction, both the structure-borne sound sensor 41 and the acceleration sensor 42 can be independent from one another, but can also be realized in just one sensor unit 4, the separation of the two different frequency ranges for the acceleration sensor 41 and the structure-borne sound sensor 42 being realized by means of appropriate filter electronics. These two variants are represented schematically in FIGS. 1 and 2 by a dashed dividing line plotted inside a sensor unit 4. FIG. 1 shows only the combined sensor unit 4, it also being possible inside the sensor unit 4 for the structure-borne sound sensor 42 to be separated from the acceleration sensor 41 and arranged at any of the positions in the vehicle labeled with the reference character 4. Irrespective of which variant they are arranged in, however, both the structure-borne sound sensor 42 and the acceleration sensor 41 with the evaluation unit 2 are always signally connected to one another. Preferably, as depicted in FIG. 1, the evaluation unit 2′ and the combined sensor unit 4 are arranged inside the central control unit 2.

If, however, the combined sensor unit 4 is arranged, for example, on the front cross member or in another decentralized position as a satellite unit, then the data must be digitized prior to transfer from the combined sensor unit 4 to the central control unit 2 and transmitted to a communication unit (not shown) in the combined sensor unit 4, which digitizes the sensor values a, aks, processes them by means of an appropriate communication protocol and transmits them to the central control unit 2. There, corresponding receiving means must be provided which can decode the digitized sensor signals again and can feed them to an appropriate evaluation algorithm inside the evaluation unit 2′.

FIG. 4 shows schematically a vehicle's longitudinal member in a case of deformation in a longitudinal direction, which is indicated by the arrow. The physical relationship for the sound power P emitted during deformation of the vehicle's longitudinal member is assumed to be as follows:

P=S·\dot{V}=S·A·v,

where
P is the sound power in W,
S is the potential sound energy density in Jm⁻³,
A is the impact surface in m²,
v is the impact velocity in ms⁻¹ and
\dot{V} is the volume deformation rate in m³s⁻¹.

The potential sound energy density constitutes a material-dependent constant. It is specific to a defined vehicle part and can be determined empirically. The volume deformation rate is the volume of material deformed per unit of time. It can also be specified by means of the deformation velocity and the impact surface A of the area of the deformed part. From this relationship, the direct dependence of the power of the emitted structure-borne sound P on the deformation velocity v can be deduced.

During the impact of a vehicle, a total signal is produced from the deformation of all the vehicle parts involved.

However, in first approximation it is assumed that the rigid vehicle part, as depicted in FIG. 1, will behave together like a solid body according to FIG. 4, influences of the remaining parts of the bodywork which do not form part of the rigid structure of the vehicle being negligible. To this extent, the above relationship in respect of the sound power P is applied to the vehicle as a whole.

A measure of the sound power P is, for example, the absolute value of the structure-borne sound signal aks, optionally filtered in signal pre-processing, the preferably time-normalized time integral thereof, the square of the structure-borne sound signal aks or the preferably time-normalized time integral thereof.

Via the known, empirically determined potential sound energy density S, the sound power P which can be measured in this way is consequently directly proportional to the volume deformation rate \dot{V}. This volume deformation rate \dot{V} is used as a second impact variable in order to change a threshold-value characteristic curve.

FIG. 5 shows the physical model on which the vehicle impact is based in relation to the measurable low-frequency acceleration signal a. It is essentially a spring-mass model. The force arising in the case of an impact is viewed as a function of the deformation, in particular of the deformation path, i.e. for example in the case of a frontal impact, the length of the deformed area X reached over the length of the impact. The deformed material of the motor vehicle inside the deformation length X is approximated as a spring with a spring constant, the so-called crash rigidity C. The total vehicle mass, which is known at least approximately for each vehicle model, is approximated as a homogeneous mass m which acts upon the spring, and does so with an initial velocity v₀. The reference character 100 designates the obstacle against which the deformation of the spring and of the mass, which represent the vehicle 10, takes place. By means of the model described, the following differential equation is arrived at:

m·\ddot{x}=C·x

Together with the angular frequency

$${ω}_{0} = \sqrt{\frac{C}{m}} ,$$

a solution to this differential equation can be found for the active acceleration as follows:

a(t)=−v₀ω₀·sin(ω₀t)

where t represents the time. With \dot{V}=A·v₀, where A is the impact surface, ultimately the following is obtained:

\dot{a}(t)∝\dot{V}

From [1] and [4], the relationship between the first impact variable of this exemplary embodiment \dot{a} and the second impact variable \dot{V} is obtained:

$$\frac{\dot{a}}{\dot{V}} = \frac{{C}^{′}}{m} ,$$

where C′ is designated the crash hardness and is essentially the crash rigidity divided by the impact surface A (C/A).

By means of this functional relationship, the threshold-value characteristic curve (th) for the first impact variable \dot{a} can usefully be varied as a function of the second impact variable \dot{V} in accordance with the underlying physical impact model.

For the hard crash mentioned in the introduction, the deformation path X is extremely small. This is the case, for example, in an AZT crash test or in a crash test against a rigid wall, in which a comparatively short deformation path X, at least in the initial period of the impact accident, is achieved. For this case, from equation [5] above an extreme value can be specified for the first impact variable:

$$\dot{a} = {k}_{1} \cdot \frac{1}{\dot{V}} ,$$

where k₁ is an empirically determined constant for a vehicle model.

FIG. 6 shows a threshold-value characteristic curve obtained therefrom for the first impact variable \dot{a} as a function of the second impact variable \dot{V}. The hyperbolic threshold-value characteristic curve is represented as a solid line. In the representation of this threshold-value characteristic curve, values for the first impact variable \dot{a} to the right above the threshold value hyperbola can be seen as criteria for the occurrence of a hard crash, on the basis of which an occupant-restraining means should be triggered. In order to increase further the reliability of an occupant-protection system, constant minimum-deformation-rate values can also be provided and minimum acceleration increases, which are plotted in FIG. 6 as dashed lines parallel to the vertical axis and parallel to the horizontal axis. The presence of a minimum deformation rate and of a minimum acceleration increase can serve as an additional criterion for the detection of a hard crash. Consequently, the shaded area in FIG. 6 represents the range of values of \dot{a} as a function of \dot{V} which are sufficient for triggering an occupant-protection means, inasmuch as a hard crash has been classified.

FIG. 7 shows a threshold-value characteristic curve for a so-called soft crash. A soft crash is characterized by a high depth of penetration of an impacting object into the motor vehicle, with a comparatively low acceleration of the whole vehicle taking place concurrently. A soft crash is expected, for example, in a type ODB crash test or in a pole-impact crash test. By estimating a maximum value of the above equations for a maximum penetration depth, a correlation of the first impact variable \dot{a} and the second impact variable \dot{V} can be obtained as follows:

\dot{a}=k₂·V³,

where k₂ again represents a vehicle-specific constant. From this follows the cubic threshold-value characteristic curve as a function of the volume deformation rate \dot{V} (second impact variable), shown in FIG. 7 as a solid line. All the values for the change in acceleration \dot{a} (first impact variable) to the right of the threshold-value characteristic curve (th) are considered a triggering criterion. In addition, what is plotted as a dashed line—again a minimum deformation rate, plotted as a dashed line parallel to the vertical axis, and a minimum acceleration increase, plotted as a dashed line parallel to the vertical axis—can be specified as an additional triggering criterion, as in the case of FIG. 6.

FIG. 8 shows a combination of the threshold-value characteristic curves from FIGS. 6 and 7. Only the dashed area to the left of the threshold-value characteristic curve (th) represents cases in which an occupant-protection means is not to be triggered. Using this combined threshold-value characteristic curve (th), the wall impact events which are otherwise difficult to distinguish, the so-called AZT crash tests, both so-called hard crash types and more often soft ODB crash type, can now be distinguished from one another.

Vehicle impacts can broadly be classified under three, optionally also more, impact types, for example hard, intermediate and soft impacts. Plotting a set of characteristic curves of the first impact variables a obtained for an impact shows that the characteristic curves for these typical impact types each run at least approximately about a line through the origin, labeled in FIG. 8 with the reference characters I, II and III, for a hard, an intermediate and a soft impact respectively.

FIG. 9 shows the schematic sequence of a method according to the invention. In method step 1, the acceleration sensor 41 records the acceleration signal a and the structure-borne sound sensor 42 records the structure-borne sound signal aks.

The acceleration signal is differentiated in a further method step 21, and the structure-borne sound signal aks is converted in a method step 22 into a change in volume \dot{V}. The change in acceleration \dot{a} and the change in volume \dot{V} are converted in a further method step 31 for calculating the hardness C′ of the impact in accordance with the physical correlations stated previously. In a further method step 51, it is established whether the crash concerned is a “soft crash” or a “hard crash”.

The result from method step 51, together with the change in acceleration \dot{a} and the change in volume \dot{V}, is used within a further method step 32 to change, on the basis of a physical impact model stored in an evaluation unit 2′, a threshold-value characteristic curve (th).

In the method sequence shown here, the threshold-value characteristic curve which is shown in FIG. 8 for example, is composed in particular of two sections: one section which is obtained from a model for a “hard crash” and a further section which is obtained for a “soft crash”.

In a further method step 52, the change in acceleration is compared against the threshold-value characteristic curve obtained in this way. If the change in acceleration \dot{a} is exceeded, then in a further method step 61, a triggering signal for an occupant-protection means is emitted and the occupant-protection means is triggered.

1-8. (canceled)

9. A method for triggering a personal protection device for a vehicle, the method which comprises:
providing an acceleration sensor forming a first impact sensor and generating therewith an acceleration signal forming a first impact signal;
comparing a first impact variable, derived from the acceleration signal, with a threshold value;
providing a structure-borne sound sensor forming a second impact sensor and generating therewith a structure-borne sound signal forming a second impact signal;
deriving a second impact variable from the second impact signal;
varying the threshold value as a function of the second impact variable;
triggering the personal protection device only when the acceleration signal exceeds the threshold value;
wherein the second impact variable represents, at least approximately, a measure of a change in a volume of the vehicle during impact, and wherein the second impact variable is proportional to a sound power, to a mean sound power, or to a sound energy of the structure-borne sound signal.

10. The method according to claim 9, wherein the personal protection device is an occupant-protection means in a vehicle.

11. The method according to claim 9, which comprises forming the second impact variable is formed by an absolute value of the measured structure-borne sound signal or of a time-normalized integral thereof.

12. The method according to claim 9, which comprises deriving the second impact variable from an absolute value of the measured structure-borne sound signal or of a time-normalized integral thereof.

13. The method according to claim 9, which comprises forming the second impact variable from a square of the measured structure-borne sound signal or of a time-normalized integral thereof.

14. The method according to claim 9, which comprises deriving the second impact variable from a square of the measured structure-borne sound signal or of a time-normalized integral thereof.

15. The method according to claim 9, wherein the first impact variable is a measure of a change in acceleration.

16. The method according to claim 9, which comprises setting the threshold value, at least in sections, inversely proportional to the second impact variable.

17. The method according to claim 9, which comprises setting the threshold value, at least in sections, proportional to a cube of the second impact variable.

18. A device for triggering a personal protection device of a vehicle, comprising:
an acceleration sensor forming a first impact sensor;
a structure-borne sound sensor forming a second impact sensor;
an evaluation unit connected to receive output signals from said first and second impact sensors; and
means configured to implement the method according to claim 9.

19. The device according to claim 18, wherein the personal protection device is an occupant-protection device in a vehicle.

20. The device according to claim 18, wherein said acceleration sensor and said structure-borne sound sensor are formed by a common sensor unit having a shared sensor unit measuring a broadband acceleration signal, and further comprising a low-pass filter for generating a low-frequency acceleration signal and a high-pass filter for generating structure-borne sound signal.
